(19) United States
(12) Patent Application Publication
(10) Pub. No.: US 2015/0228441 A1
(43) Pub. Date: Aug. 13, 2015

(54) DEVICE COMPRISING AN ANODE FOR GENERATING X-RAY RADIATION

(71) Applicant: SIEMENS AKTIENGESELLSCHAFT, München (DE)

(72) Inventors: Svetlana Gossmann-Levchuk, Erlangen (DE); Oliver Heid, Erlangen (DE); Timothy Hughes, Wantage (GB); Thomas Kluge, Hirschaid (DE)

(21) Appl. No.: 14/428,374

(22) PCT Filed: Sep. 21, 2012
(86) PCT No.: PCT/EP2012/068616

§ 371 Date: Mar. 16, 2015

(51) Int. Cl. H01J 35/10; H01J 35/06

(52) U.S. Cl. CPC H01J 35/108; H01J 35/06; H01J 2235/086; H01J 2235/18; H01J 2235/081

(57) ABSTRACT

An anode for generating X-radiation having a holder and a target layer held by the holder, the target layer comprising a middle section and an edge section, is provided. The anode is provided for being exposed to an electron beam directed at the middle section of the target layer. The edge section is arranged laterally next to the middle section in relation to the direction of the electron beam. Furthermore, the edge section is thicker than the middle section in the direction of the electron beam.

### CROSS-REFERENCE TO RELATED APPLICATIONS

This application claims priority to PCT Application No. PCT/EP2012/068616, having a filing date of Sep. 21, 2012, the entire contents of which are hereby incorporated by reference.

### FIELD OF TECHNOLOGY

The following relates to an anode for generating x-ray radiation.

### BACKGROUND

X-ray tubes for generating x-ray radiation are known from the prior art. X-ray tubes have a cathode for emitting electrons. The emitted electrons are accelerated by a high voltage onto an anode. In the anode, the electrons are decelerated and, in the process, generate x-ray bremsstrahlung and characteristic x-ray radiation. X-ray bremsstrahlung has a broad spectral distribution, while characteristic x-ray radiation has a discrete line spectrum. In the x-ray radiation radiated by the x-ray tube, both types of radiation are superposed.

For specific usage purposes, characteristic x-ray radiation with discrete energies is more suitable than x-ray bremsstrahlung. It is known to filter x-ray radiation using metallic filters in order to reduce the bremsstrahlung portion. However, such filters also dampen the portion of characteristic x-ray radiation.

### SUMMARY

An aspect relates to an improved anode for generating x-ray radiation. A further object aspect relates to providing an improved device for generating x-ray radiation.

An anode according to embodiments of the invention for generating x-ray radiation has a holder and a target layer held by the holder. Here, the target layer comprises a central portion and an edge portion. The anode is provided to be exposed to an electron beam directed onto the central portion of the target layer. Here, the edge portion is arranged laterally next to the central portion in relation to the direction of the electron beam. Moreover, the edge portion has a greater thickness in the direction of the electron beam than the central portion. Advantageously, the edge portion of the target layer of this anode can serve to filter x-ray radiation generated in the central portion of the target layer of the anode. As a result, a monochromaticity of the x-ray radiation generated by the anode advantageously improves.

In a preferred embodiment of the anode, the edge portion is raised over the central portion in a direction opposite to the direction of the electron beam. Advantageously, the x-ray radiation generated in the central portion of the target layer can then be emitted against the beam direction of the electron beam and, in the process, pass through part of the edge portion of the target layer of the anode, as a result of which a continuous wavelength portion of the x-ray radiation is damped.

In one embodiment of the anode, the edge portion is arranged around the central portion in a ring-shaped manner. Advantageously, the edge portion can then provide filtering of x-ray radiation emitted in different spatial directions.

In a preferred embodiment of the anode, the target layer has an embodiment with a uniform material. Advantageously, this results in a particularly simple setup of the target layer, and of the whole anode as well.

In an expedient embodiment of the anode, the target layer has a material with an atomic number of between 42 and 74. Advantageously, these materials are particularly well suited to generating x-ray radiation.

In a particularly preferred embodiment of the anode, the target layer has tungsten. Advantageously, tungsten is well suited to generating and filtering x-ray radiation.

In one embodiment of the anode, the central portion has a thickness of between 50 nm and 10 μm. Advantageously, this thickness range was found to be particularly suitable.

In a likewise preferred embodiment of the anode, the central portion has a diameter of between 1 mm and 20 mm perpendicular to the direction of the electron beam. Advantageously, these values were found to be particularly suitable.

A device according to embodiments of the invention for generating x-ray radiation has a cathode for emitting an electron beam and an anode of the aforementioned type. Here, the anode is arranged in such way that an electron beam emitted by the cathode is incident on the central portion of the target layer. Advantageously, x-ray radiation generated in the central portion of the target layer of the anode can be filtered by the edge portion of the target layer of the anode in this device, as a result of which a monochromaticity of the generated x-ray radiation improves.

In a preferred embodiment of the device, the anode is arranged in such a way that an electron -beam emitted by the cathode is incident perpendicularly on the central portion of the target layer. Advantageously, this results in a symmetric and compact setup of the device.

In a preferred embodiment of the device, the latter has a window for guiding out x-ray radiation generated in the target layer. Here, the window is arranged in such a way that x-ray radiation generated in the central portion of the target layer and guided out through the window first penetrates the edge portion of the target layer. Advantageously, the x-ray radiation generated in the central portion of the target layer is then filtered when penetrating the edge portion of the target layer, as a result of which a monochromaticity of this x-ray radiation is increased.

In a preferred embodiment of the device, the window is arranged in such a way that guided-out x-ray radiation penetrates the edge portion of the target layer over a length of, on average, between 10 μm and 100 μm. It was found that such a penetration length leads to an advantageous increase in the monochromaticity of the x-ray radiation, without the overall intensity of the x-ray radiation being attenuated too strongly.

In a preferred embodiment of the device, the window is arranged in such a way that x-ray radiation directed backward in relation to the direction of the electron beam can be guided out through the window. Advantageously, the backward-directed x-ray radiation has a higher portion of characteristic x-ray radiation than forward-directed x-ray radiation, and so the x-ray radiation guided out of the device after filtering by the edge portion of the target layer of the anode has a particularly high monochromaticity.

In a preferred embodiment of the device, the latter has a collector provided to capture electrons of the electron beam which have penetrated the anode. Advantageously, a circuit between the cathode and the collector of the device can be closed by the collector, as a result of which an energy efficiency of the device improves.

### BRIEF DESCRIPTION

The above described properties, features and advantages of this invention, and the manner in conjunction with the drawings. In detail:

Some of the embodiments will be described in detail, with reference to the following figures, wherein like designations denote like members, wherein:

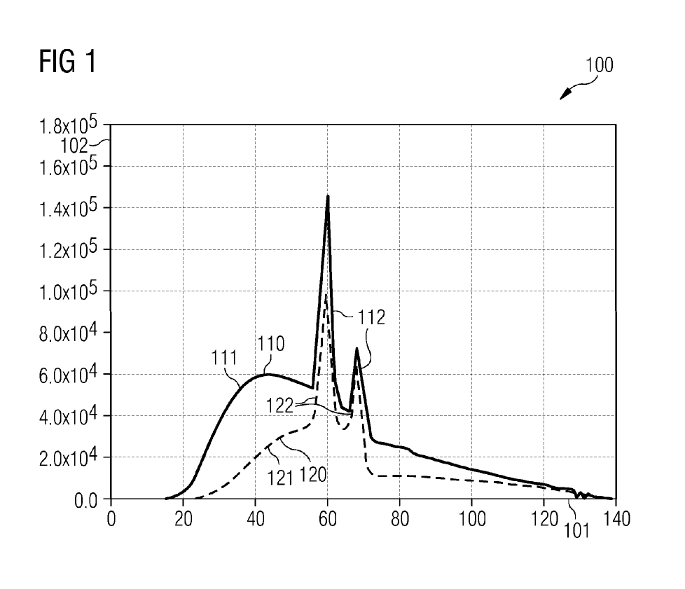

FIG. 1 shows an x-ray spectrum emitted by an x-ray tube comprising an anode with a tungsten target layer;

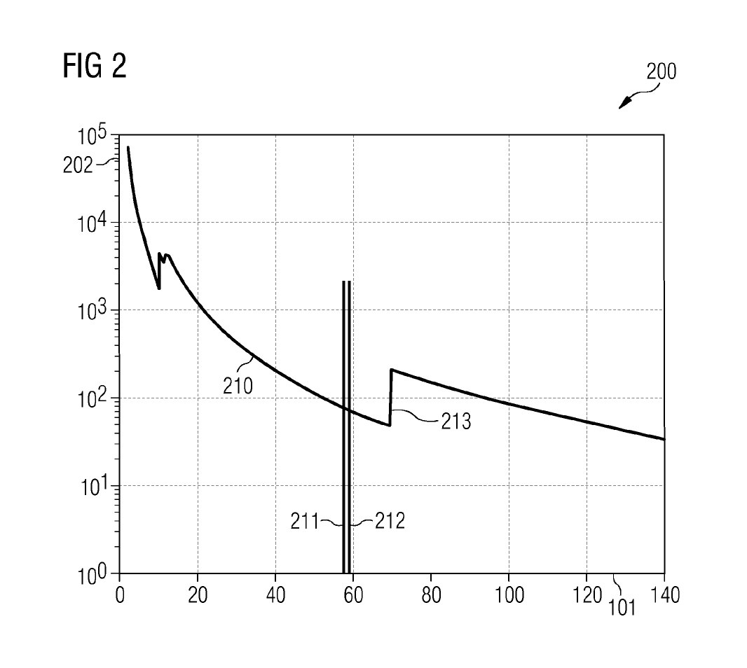

FIG. 2 shows a linear absorption coefficient of tungsten;

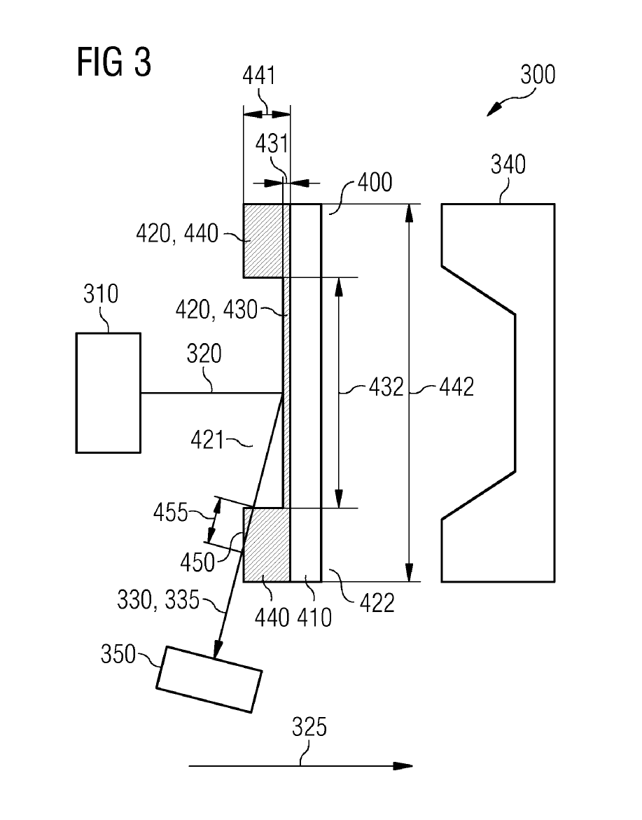

FIG. 3 shows a schematic illustration of an embodiment of a device for generating x-ray radiation;

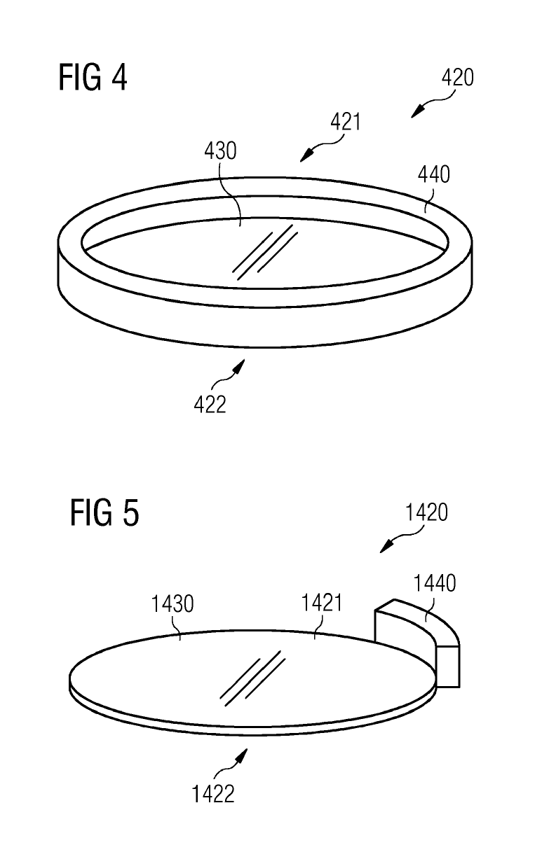

FIG. 4 shows a schematic perspective illustration of a target layer of an anode in accordance with a first embodiment; and

FIG. 5 shows a schematic perspective illustration of a target layer of an anode in accordance with a second embodiment.

### DETAILED DESCRIPTION

FIG. 1 shows a graph of an x-ray spectrum 100. Energy 101 in keV is plotted on a horizontal axis. A photon flux 102 in 1/(keV·mA·mm²·s) is plotted on a vertical axis.

A first spectrum 110 specifies the spectral distribution of x-ray radiation, which was emitted by a tungsten target layer of an anode of an x-ray tube and filtered by a filter made of aluminum with a thickness of 2 mm. The first spectrum 110 has a continuous portion of bremsstrahlung 111. Moreover, the first spectrum 110 has maxima at discrete energy values, which are formed by characteristic x-ray radiation 112.

FIG. 2 shows, on the basis of a graph 200, damping of x-ray radiation by a filter made of tungsten. A horizontal axis once again plots the energy 101 in keV. A vertical axis plots an absorption coefficient 202 in cm⁻¹.

FIG. 2 shows a profile 210 of the linear absorption coefficient of tungsten. It is possible to identify that the linear absorption coefficient of tungsten decreases with increasing energy. However, the absorption coefficient profile 210 has a K-edge 213, at which the falling absorption coefficient profile 210 increases abruptly. The K-edge 213 occurs at an energy 101 corresponding to a binding energy of electrons arranged in the K-shell of tungsten atoms.

Furthermore, the diagram 200 in FIG. 2 marks energy values of two important lines in the characteristic x-ray radiation of tungsten. These are the K_{α1} line 211 and the K_{α2} line 212.

If x-ray radiation with the first x-ray spectrum 110 depicted in FIG. 1 is filtered by an additional filter made of tungsten, there is additional damping of this x-ray radiation. As a result of the K-edge 213 in the absorption coefficient profile 210 of tungsten, higher energy components of the first spectrum 110 are damped more strongly in the process than the region of the K_{α1} line and the K_{α2} line of the characteristic x-ray radiation 112 of the first spectrum 110. As a result, the relative intensity of the aforementioned lines increases in the spectrum of the filtered x-ray radiation.

On the basis of a second spectrum 120, FIG. 1 shows the spectral distribution of the x-ray radiation of the first spectrum 110 after additional filtering 110 using a tungsten filter with a thickness of 50 μm. It is possible to identify that the portion of the bremsstrahlung 121 in the second spectrum 120 is greatly reduced relative to the portion of the bremsstrahlung 111 in the first spectrum 110. The portion of characteristic x-ray radiation 122 in the second spectrum 120 is less strongly damped than the portion of characteristic x-ray radiation 112 in the first spectrum 110. As a result of this, the second spectrum 120 has a higher monochromaticity than the first spectrum 110.

FIG. 3 shows a very schematic illustration of a section through a device 300 for generating x-ray radiation. The components of the device 300 for generating x-ray radiation depicted in FIG. 3 can e.g. be arranged in a vacuum tube. In this case, the device 300 for generating x-ray radiation can also be referred to as an x-ray tube.

The device 300 for generating x-ray radiation has a cathode 310. The cathode 310 is provided for emitting electrons in order to generate an electron beam 320. By way of example, the cathode 310 can emit the electrons by thermal emission or field emission. The electron beam 320 formed by the electrons emitted by the cathode 310 is accelerated in a beam direction 325 by high voltage (not depicted here).

The device 300 for generating x-ray radiation further comprises an anode 400. The anode 400 has a holder 410 and a target layer 420 held by the holder 410. The target layer 420 in turn comprises a central portion 430 and an edge portion 440. The edge portion 440 is arranged laterally offset next to the central portion 430 in relation to the beam direction 325.

The central portion 430 and the edge portion 440 preferably have an embodiment with uniform material. Here, the central portion 430 and the edge portion 440 of the target layer 420 preferably consist of a material with an atomic number of between 42 and 74. The central portion 430 and the edge portion 440 of the target layer 420 particularly preferably consist of tungsten. By way of example, the holder 410 can consist of diamond.

The anode 400 has a front side 421 and a rear side 422. The front side 421 of the anode 400 faces the cathode 310. The anode 400 is arranged in such a way that the electron beam 320 emitted by the cathode 310 is incident approximately perpendicularly on a central region of the central portion 430 of the target layer 420.

The electron beam 320 incident on the central portion 430 of the target layer 420 of the anode 400 is decelerated in the central portion 430 of the target layer 420, with x-ray radiation 330 being generated in the process. This x-ray radiation 330 is emitted in several or all spatial directions, inter alia in an emission direction 335. The emission direction 335 is preferably oriented backward in relation to the beam direction 325 of the electron beam 320. This means that the emission direction 335 of the central portion 430 of the target layer 420 of the anode 400 points in the half space in which the cathode 310 is arranged.

The device 300 for generating x-ray radiation has a window 350, which serves to guide x-ray radiation 330 emitted in the emission direction 335 out of the device 300. The window 350 can consist of e.g. aluminum or beryllium.

The central portion 430 of the target layer 420 has a diameter 432 perpendicular to the beam direction 325. By way of example, the diameter 432 can lie between 1 mm and 20 mm. In the beam direction 325, the central portion 430 of the target layer 420 has a thickness 431. By way of example, the thickness 431 can lie between 50 nm and 10 μm. The edge portion 440 of the target layer 420, arranged externally around the central portion 430 in the depicted example, has a diameter 442 which is greater than the diameter 432 of the central portion 430. Moreover, the edge portion 440 of the target layer 420 has a thickness 441 in the beam direction 325 which is greater than the thickness 431 of the central portion 430. Here, the edge portion 440 is raised over the central portion 430 of the target layer 420 on the front side 421 (i.e. against the beam direction 325).

Thickness 441 and diameter 442 of the edge portion 440 of the target layer 420, the diameter 432 of the central portion 430 of the target layer 420 and the position of the window 350 are matched to one another in such a way that x-ray radiation 330, emitted in the emission direction 335 by the central portion 430 of the target layer 420 of the anode 400, passes through a part of the edge portion 440 of the target layer 420 serving as a filter region 450 on its way to the window 350. Here, the x-ray radiation 330 passes through the filter region 450 of the edge portion 440 over a penetration length 455 which, on average, may be between 10 μm and 100 μm for example. During the penetration of the filter region 450, the x-ray radiation 330 is filtered such that the monochromaticity thereof increases, as explained on the basis of FIGS. 1 and 2.

The device 300 for generating x-ray radiation furthermore comprises a collector 340, which is arranged behind the anode 400 in the beam direction 325. The collector 340 serves to collect electrons of the electron beam 320 which have passed through the anode 400. The electrons collected by the collector 340 can be led back in an electric circuit, as a result of which an energy efficiency of the device 300 for generating x-ray radiation is improved.

FIG. 4 shows a schematic perspective illustration of the target layer 420 of the anode 400 of the device 300 for generating x-ray radiation from FIG. 3. It is possible to identify that the edge portion 440 is arranged around the central portion 430 of the target layer 420 in a ring-shaped manner. This embodiment of the target layer 420 is advantageous in that the anode 400 in the device 300 for generating x-ray radiation can be rotated about an axis of rotation parallel to the electron beam 320. This leads to uniform heating and wear of the target layer 420 of the anode 400 during operation of the device 300 for generating x-ray radiation. However, it is also possible to dispense with rotating the anode 400.

FIG. 5 shows a schematic perspective illustration of a target layer 1420 in accordance with a second embodiment. The target layer 1420 of FIG. 5 can replace the target layer 420 of the anode 400 of the device 300 for generating x-ray radiation of FIG. 3. The target layer 1420 once again comprises a central portion 1430 and an edge portion 1440. The target layer 1420 has a front side 1421 and a rear side 1422. The target layer 1420 is provided for being held by the holder 410 of the anode 400 in such a way that the electron beam 320 generated by the cathode 310 is incident on the front side 1421 of the central portion 1430.

In contrast to the edge portion 440 of the target layer 420, the edge portion 1440 of the target layer 1420 in FIG. 5 is not arranged in a ring-shaped manner around the whole central portion 1430 of the target layer 1420. Rather, the edge portion 1440 has the form of a circular ring sector, which is arranged laterally next to the central portion 1430 of the target layer 1420 over merely a restricted angular range. Here, the edge portion 1440 is arranged next to the central portion 1430 of the target layer 1420 in such a way that x-ray radiation 330 generated in the central portion 1430 of the target layer 1420 penetrates the edge portion 1440 of the target layer 1420 in the emission direction 335. The anode 400 is not rotated when using the target layer 1420 in the anode 400 of the device 300 for generating x-ray radiation.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An anode for generating x-ray radiation, comprising;
a holder; and
a target layer held by the holder, the target layer comprising a central portion and an edge portion,
wherein the anode is provided to be exposed to an electron beam directed onto the central portion of the target layer
wherein the edge portion is arranged laterally next to the central portion in relation to a direction of the electron beam;
wherein the edge portion has a greater thickness in the direction of the electron beam than the central portion.

2. The anode as claimed in claim 1, wherein the edge portion is raised over the central portion in a direction opposite to the direction of the electron beam.

3. The anode as claimed in claim 1, wherein the edge portion is arranged around the central portion in a ring-shaped manner.

4. The anode as claimed in claim 1, wherein the target layer is comprised of a uniform material.

5. The anode as claimed in claim 1, wherein the target layer is comprised of a material with an atomic number of between 42 and 74.

6. The anode as claimed in claim 5, wherein the target layer is comprised of tungsten.

7. The anode as claimed in claim 1, wherein the central portion has a thickness of between 50 nm and 10 μm.

8. The anode as claimed in claim 1, wherein the central portion has a diameter of between 1 mm and 20 mm perpendicular to the direction of the electron beam.

9. A device for generating x-ray radiation, comprising a cathode for emitting an electron beam and an anode as claimed in claim 1, wherein the anode is arranged in such a way that an-the electron beam emitted by the cathode is incident on the central portion of the target layer.

10. The device as claimed in claim 9, wherein the anode is arranged in such a way that an-the electron beam emitted by the cathode is incident perpendicularly on the central portion of the target layer.

11. The device as claimed in claim 9, further comprising a window for guiding out x-ray radiation generated in the target layer, wherein the window is arranged in such a way that x-ray radiation generated in the central portion of the target layer and guided out through the window first penetrates the edge portion of the target layer.

12. The device as claimed in claim 11, wherein the window is arranged in such a way that guided-out x-ray radiation penetrates the edge portion of the target layer over a length on average, between 10 μm and 100 μm.

13. The device as claimed in claim 11, wherein the window is arranged in such a way that x-ray radiation directed backward in relation to the direction of the electron beam is guided out through the window.

14. The device as claimed in claim 9, further comprising a collector provided to capture electrons of the electron beam which have penetrated the anode.
